(19) United States
(12) Patent Application Publication
(10) Pub. No.: US 2022/0039566 A1
(43) Pub. Date: Feb. 10, 2022

(54) Consumer Product Holder Device

(71) Applicant: Andrew G. Klaiber, Trumbull, CT (US)

(72) Inventor: Andrew G. Klaiber, Trumbull, CT (US)

(21) Appl. No.: 17/209,402

(22) Filed: Mar. 23, 2021

Related U.S. Application Data
(60) Provisional application No. 63/061,407, filed on Aug. 5, 2020.

(51) Int. Cl. A47F 5/04; A47F 7/28; G09F 23/00

(52) U.S. Cl. CPC A47F 5/04; A45B 23/00; G09F 23/00; A47F 7/28

(57) ABSTRACT

The consumer product holder device of the present invention provides a user with a centrally located, free standing device which can hold multiple beverages and other consumers products simultaneously. More specifically, the consumer product holder device provides a place for the user to hold multiple products in color-coded or personalized beverage holders to keep a beverage and other items or products within arms-length. The device also provides users with a convenient place to store trash, supplies, or sporting items, and to connect an accessory, such as a dry-erase board, light, flag, speaker or other item.

### CROSS-REFERENCE TO RELATED APPLICATION

The present application claims priority to, and the benefit of, U.S. Provisional Application No. 63/061,407, which was filed on Aug. 5, 2020, and is incorporated herein by reference in its entirety.

### FIELD OF THE INVENTION

The present invention relates generally to the field of consumer product holders that provide users with a centrally located, free standing device for holding multiple beverages or other consumer products in an easily accessible manner. More specifically, the present invention relates to a beverage or consumer product holder equipped with, among other things, multiple holders or supports of various colors and sizes, a bag holder, bottle opener, and an accessory connection. The consumer product holder device of the present invention allows a user to participate in a variety of activities, such as golf, cornhole, volleyball, badminton, relaxing, socializing and the like, while providing a convenient and secure location for beverage containers and other consumer products.

More specifically, the plurality of color-coded beverage and consumer product holders are attached to the vertical support and may be used to support a variety of containers including, without limitation, cans, plastic bottles, reusable drinking devices, cups, snacks, packages, etc. to allow users a place to set their beverages or other products without the fear of another individual drinking from the wrong beverage or consuming the snack belonging to someone else. Additionally, a bag holder, bottle opener and a connection for which a user can affix an accessory, such as a dry-erase board, light, or hook, are also provided. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, many individuals enjoy activities while also drinking from a beverage container or having a snack. In order to participate in an activity, such as cornhole, the individual will need to place his/her beverage or other consumer product down so as to free up both hands for the activity. Accordingly, the beverage container, such as a can, bottle, cup, mug or the like, may tip over onto the ground, thereby spilling the contents. Or, the individual asked to hold the beverage container may accidently drink from another individual's beverage container. Additionally, having to continually hold a beverage or a snack also prevents the user from being able to use both hands to engage in a separate activity, and holding a beverage or a snack separately while participating in a sporting activity could cause the user to spill the beverage and/or contents of the snack package, or drop the container onto the ground. This, in turn, may cause other ramifications depending on the type of beverage or snack, whether the user is on a beach, a patio or deck, or in other undesirable situations.

Further, many individuals participating in activities do not have a convenient location to hold trash, supplies, or additional items causing the individual to have to leave the area of the activity. More often than not, the user will accumulate trash or other items that need disposing of while participating in certain activities. Without access to a trash can or other receptacle, the individual will need to either hold on to the trash or items until such time as he/she finds an appropriate place to dispose of or store the items, or place the trash on the ground. In addition, activities may have items or supplies that are necessary. For example, badminton has shuttlecocks and rackets. Many times, there are several shuttlecocks and, if a secure place is not available, they may be lost when setting them on the ground for later use.

Therefore, there exists a long-felt need in the art for an improved beverage and consumer product holding device that is centrally located, free standing, and allows users a place to securely keep multiple beverages and other items simultaneously. More specifically, there is a long-felt need in the art for an improved beverage or consumer product holding device that contains multiple secure holders to place beverages and other products into, without requiring the user to continuously hold the same. Additionally, there is a long-felt need in the art for an improved beverage or other product holding device that enables a user to remove the lids or tops from bottles, and that also provides a mechanism to allow the user to attach a bag to collect items, such as garbage, supplies or accessories. Moreover, there is a long-felt need in the art for an improved beverage or other product holding device that is capable of also supporting a number of accessories such as, but not limited to, a dry-erase board, sign, umbrella, light, etc. Finally, there is a long felt need in the art for an improved beverage or other product holding device that is relatively inexpensive to manufacture, and that is both safe and easy to use.

The subject matter disclosed and claimed herein, in one embodiment thereof, comprises a beverage supporting device having a vertical member, a stand for supporting the vertical member, multiple holders or supports extending outwardly from the vertical member, a bottle opener, and a bag holder. The vertical structure is relatively lightweight and is used to support the multiple holders or keepers, an accessory holder, and a bag holder. The vertical structure is generally comprised of two rods that affix vertically to one another, thereby creating one continuous rod approximately five feet in length. The stand allows the device to be free standing on many different types of surfaces, and may also be provided with anchors or one or more ground stake(s) that may be extended below the ground or surface on which the base is placed in order to better stabilize the device when placed on uneven or soft ground. The holders are attached along the length of the vertical member, and may be color coded so that they can be assigned to different users. In addition, the device has a detachable bag holder for supporting a bag, such as a trash bag or supply bag, and a bottle opener attached to the vertical structure to enable the user to remove the top or lid off of bottles or other beverage containers. Finally, the vertical member may further comprise one or more hooks, catches, pegs, etc. for holding keys, a smartphone, wireless speakers, etc.

In this manner, the consumer product holding device of the present invention accomplishes all of the forgoing objectives and provides a relatively safe, easy, convenient and cost-effective solution to allow users to place multiple beverages in the same location, separated by user and elevated above the ground, while enjoying a variety of activities. The novel consumer product holding device also provides the user with the ability to collect trash and attach accessories to the device.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The present invention relates to a novel consumer product holding device equipped with one or more beverage, consumer product or other holder or keeper components suitable for holding one or more containers, packages or accessories. As used herein, the term “container” refers to one of a cup, can, glass, mug, bottle, juice box, or the like. “Containers” are typically used for holding consumer products, both those intended for human consumption (e.g., coffee, tea, soda, alcohol) and those that are not, such as a smartphones, keys, food, or the like. Although the preferred use of the consumer product holding device of the present invention is for containers intended for human consumption, it is not so limiting, and may be used for any other purpose that satisfies the needs and/or preferences of the user.

The present invention also relates to a novel beverage device equipped with a bag holder and other holder components suitable for holding a bag or other accessories, such as keys, smartphones, speakers or the like. As used herein, the term “bag” refers to any container constructed of a flexible material with an opening suitable for carrying items. “Bags” are typically used for carrying items of various weights and sizes.

The subject matter disclosed and claimed herein, in one embodiment thereof, comprises a consumer product holding device that allows users a place to securely hold multiple beverages and other consumer products, while preventing contamination or spills of those beverages or packages. The vertical support member is an elongated and rigid central stand which, when assembled, extends approximately five feet tall and attaches to a stand or base in order for the device to be free standing on both even and uneven surfaces, as well as permeable and solid surfaces, such as grass, sand, concrete, wood, steel, and the like. The vertical support member is preferably comprised of two or more shorter members attached to one another in series when in use, but that may be easily disassembled for easy transportation and storage when not in use. The two or more sub-members may be of equal length or of differing lengths, and the device may further comprise extender poles that can be inserted into one end of the sub-members to extend the overall length thereof.

In a further embodiment of the present invention, the consumer product holding device further comprises a plurality of beverage holders. Each of the plurality of beverage or consumer product holders are attached along the vertical support poles, preferably in a spaced apart fashion, and provides a place for multiple individuals to place their beverages and other consumer products close at hand. Each of the plurality of beverage or consumer product holders is preferably of a generally cylindrical shape and is sized to be able to secure many different types of containers or packages including, without limitation, cans, glasses, bottles, cups, single service bags, juice boxes or the like. Further, the beverage holders are color-coded to assist a user in identifying his/her beverage. Alternatively, the holders may be provided with numbers or other indicia for individuals to remember which holder they placed their beverage or package into. The indicia may also reference a manufacturer's name, place, or the like, and may be used as a promotional giveaway. The side of the consumer product holder has a mounting mechanism that allows the holder to be attached and secured to the vertical member within easy reach of the user. The mounting mechanism may include, but is not limited to, two elongated key-shaped holes, slots or other similar features suitable for fastening a beverage holder to a support structure.

The consumer product holding device may further comprise a stand, or other type of base, to support the vertical support. The stand or base may also include a ground stake and four legs or weights to keep the base in proper position, and prevent the vertical pole from toppling over. The ground stake may be affixed in the upright position or extended below the stand partway into the ground beneath for further stability. The legs of the stand provide the necessary support to prevent the device from wobbling, tilting or falling.

In a still further embodiment of the present invention, the consumer product holding device further includes a bottle opener, corkscrew or other form of can or bottle opener. The bottle or can opener is preferably comprised of a base and a leverage cap hook. When the leverage cap hook is in a fully open position, a user is able to remove the top or cap from a bottle. The bottle or can opener can be attached anywhere along the device, but it is preferably positioned along the vertical member for easy access. More specifically, the opener may be attached to the vertical member by any suitable attachment means such as, but not limited to, screws, bolts, adhesive, hook and loop fasteners, chains, etc., provided that the same provides a safe and secure method of attaching a bottle or can opener or corkscrew with sufficient strength to withstand the force of a user removing a bottle top or cap or opening a bottle of wine with the same.

In a yet further embodiment of the present invention, the consumer product holding device includes a bag holder. The bag holder is preferably comprised of a cross member with two side bars positioned perpendicularly to the cross member and generally parallel to each other. The cross member and each of the side bars may be integrally formed, or attached to one another via any suitable attachment means including, without limitation, fasteners, adhesives, friction or interference fits, etc.

In a still further embodiment, a kit for a consumer product holding device is disclosed. The kit is preferably provided in the form of a package, wherein the package is sized and configured to hold the various components necessary to assemble the consumer product holding device of the present invention and a set of instructions for assembly/disassembly. For example, the kit may comprise first and second vertical support members, at least one extension pole for lengthening the vertical support member, a base, a plurality of holders, mounting means, stakes, etc.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the consumer product holding device of the present invention in accordance with the disclosed architecture, wherein the device is both fully deployed and free standing;

FIG. 2A illustrates a perspective view of one potential embodiment of the consumer product holding device of the present invention in accordance with the disclosed architecture, wherein the device is unassembled;

FIG. 2B illustrates a perspective view of one potential embodiment of the various beverage holders of the consumer product holding device of the present invention in accordance with the disclosed architecture;

FIG. 2C illustrates a perspective view of one potential embodiment of the consumer product holding device of the present invention in accordance with the disclosed architecture, wherein the device is unassembled;

FIG. 3 illustrates a perspective view of one potential embodiment of the consumer product holding device of the present invention in accordance with the disclosed architecture, wherein the device is fully deployed and supporting a trash bag;

FIG. 4 illustrates a perspective view of one potential embodiment of the consumer product holding device of the present invention in accordance with the disclosed architecture, wherein the device is fully deployed and supporting a plurality of different beverage containers;

FIG. 5 illustrates a perspective view of one potential embodiment of the consumer product holding device of the present invention in accordance with the disclosed architecture, wherein the device is fully deployed on a beach in close proximity to a plurality of individuals enjoying a game of cornhole;

FIG. 6 illustrates a perspective view of one potential embodiment of the consumer product holding device of the present invention in accordance with the disclosed architecture, wherein the device is fully deployed and supporting additional holders or accessory keepers; and

FIG. 7 illustrates a perspective view of one potential embodiment of the consumer product holding device kit of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

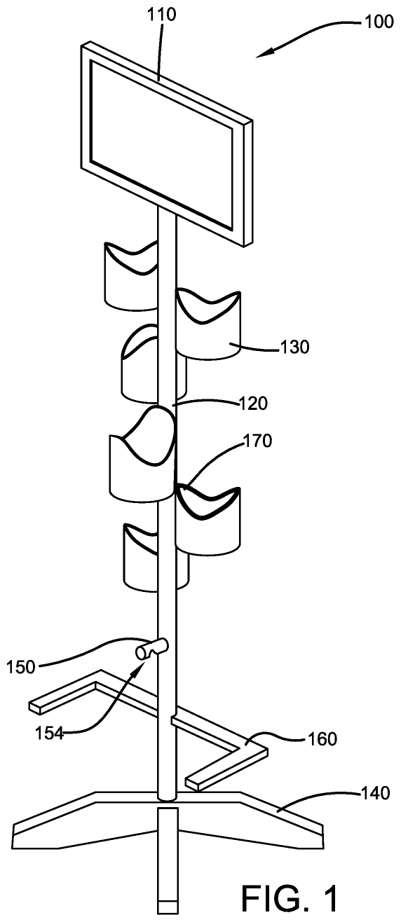

Referring initially to the drawings, FIG. 1 illustrates a perspective view of one potential embodiment of the consumer product holding device 100 of the present invention in accordance with the disclosed architecture, wherein the device 100 is both fully deployed. The device 100 is free standing in a vertical position, and is located on a solid surface or venue 200. The venue 200 may be a room in a house, bar, or other establishment, the beach, a lawn, or any other type of venue suitable to participate in sporting activities, socialization, parties or other similar activities.

The device 100 is comprised of a vertical structural support member 120 that supports a plurality of beverage or consumer product holders 130, a stand or base 140, a bottle or can opener or corkscrew 150, a bag holder 160, and an accessory holder 126. As explained more fully below, when in use, the device 100 stands freely on any relatively flat surface, and provides a convenient location for users 190 to set their beverage containers or other consumer products 180.

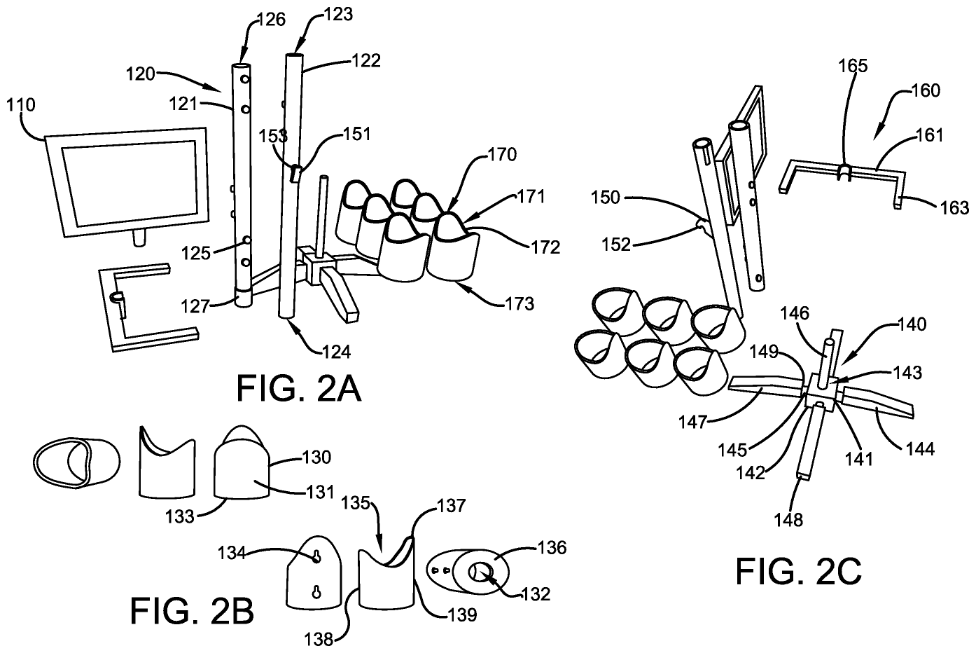

The vertical structural support 120 may be manufactured from any suitable material such as, but not limited to, plastic, steel, aluminum, wood or the like, provided the same is relatively anti-corrosive, lightweight and durable. The vertical structural support 120 is further comprised of a first vertical support rod 121, a second vertical support rod 122, a first guide channel 123, a second guide channel 124, one or more brackets 125, and an accessory connector 126. As best shown and described in FIG. 2A-C, the tapered end 127 of the first vertical support rod 121 is inserted into the first guide channel 123 of the second vertical support rod 122 to connect the two and form the vertical structural support 120. Once connected, the overall height of the vertical support member 120 is approximately five feet, though other heights are also contemplated and additional poles or rods may be provided so as to extend the height of the member 120. As explained more fully below, a stake 146 positioned atop of the base 140 is inserted into the second guide channel 124 to connect the structural support 120 to the base 140 and allow the same to remain fully upright without tilting or leaning in any direction.

As also shown in FIG. 1, in one potential embodiment, the holders 130 may be positioned at different vertical heights and at different places along the surface of the vertical structural support or pole 120 to provide users with convenient access to all beverage holders 130 simultaneously. The beverage or consumer product holders 130 are preferably situated below the accessory connector 126 and above the bottle or can opener 150, but may be placed at any position along support member 120 that the user 190 prefers. In one embodiment, each holder 130 is color-coded to allow users 190 to easily identify his/her container 180 while preventing other users 190 from picking up another user's 190 beverage by mistake. Alternatively, or in addition, each of the holders 130 may be provided with indicia (e.g., a number, letter, sports team, etc.) to differentiate each holder 130 from another.

FIG. 1 also illustrates one potential embodiment of the bottle opener 150. The bottle opener 150 is attached to the vertical structural support 120 by the bottle opener base 151. In FIG. 1, the bottle opener 150 is in a fully open position 154, meaning that the leverage cap hook 152 is generally perpendicular to the vertical structural support 120. In order to deploy the bottle opener 150 into a fully open position 154, the leverage cap hook 152 is lifted in an upward motion causing the leverage cap hook 152 to extend upward at the pivot point 153 from the bottle opener base 151.

The stand or base 140 is comprised of an inner base 141, a plurality of legs 144, and a stake 146, wherein the vertical structural support 120 is attached to the base 140 in a male/female connection via the stake 146, which protrudes upwardly from the top surface of the base 140. The stand 140 allows the vertical structural support or pole 120 to remain in a fully upright and vertical position to ensure balance and stability, and to avoid beverage containers 180 from being tilted and spilled. Weights (not shown) may also be provided to the base 140 help prevent the same and the support member 120 from tipping over in the wind or if jostled by a user 190.

As also illustrated in FIG. 1, an accessory 110 may be inserted into, or attached to, the first vertical support rod 121 at the accessory connector 126. Accessories 110 allow the device 100 to also be used as a sign, light, balloon holder, flag holder or any other function that meets the needs of the user 190. For example, in this particular illustration, a dry-erase sign is utilized whereby the user 190 can write upon it such as to keep score of a game or the names of the users 190 and their assigned color of holder 130. In addition, such accessories 110 may also allow the device 100 to be used at special occasions, such as weddings, graduations, birthday parties, etc.

FIG. 1 further illustrates a bag holder 160 next to, and detached from, the device 100. The bag holder 160 may be attached to the vertical structural support 120 and utilized to hold a bag containing, for example, trash, supplies, game pieces and the like. As described more fully in reference to FIG. 2 below, the bag holder 160 may be comprised of a relatively horizontal cross bar member 161 and two side bars 163 extending outwardly therefrom. The bag holder 160 can have a bag 164 attached thereto, and is sturdy enough to support the additional weight of the contents of the bag 164.

FIG. 2A illustrates a perspective view of one potential embodiment of the consumer product holding device 100 of the present invention in accordance with the disclosed architecture, wherein the device 100 is unassembled. As previously stated, the vertical structural support 120 has a first vertical support rod 121, a second vertical support rod 122, a first guide channel 123, a second guide channel 124, one or more brackets 125 and an accessory connector 126. As best shown in FIG. 2A, the first vertical support rod 121 has a tapered end 127 and an accessory connector 126 opposite the tapered end 127. The accessory connector 126 is compatible with any accessory 110 that suits user need and/or preference such as a dry-erase board, light, umbrella, bowl, hook to hang balloons, ribbons or coats or the like.

In a preferred embodiment, the first vertical support rod 121 has a generally cylindrical shape, but the same is not so limited and may be any shape and size to meet the needs of the user 190. Four brackets 125 are generally located at different heights and locations along the first vertical support rod 121. The brackets 125 support the detachable holders 130 which are spaced far enough apart to provide for various sizes and shapes of containers or packages to be placed into the holders 130. The second vertical support rod 122 is comprised of a first guide channel 123 and a second guide channel 124. In a preferred embodiment, the second vertical support rod 122 is made of the same material and has the same shape as the first vertical support rod 121, but may also be any shape and size to meet the needs of the user 190 while also connecting to the first vertical support rod 121.

A bottle opener 150 is located along the surface of the second vertical support rod 122, and is comprised of a bottle opener base 151 and a leverage cap hook 152. The bottle opener base 151 is affixed to the second vertical support rod 122. In a preferred embodiment, the bottle opener base 151 is of a shape that sits relatively flush with the second vertical support rod 122. However, the bottle opener base 151 may be of any shape or size suitable for its intended purpose. The leverage cap hook 152 is attached to the bottle opener base 151 at the pivot point 153. When the leverage cap hook 152 is lifted to a fully open position 154, the leverage cap hook 152 is configured to receive a shape of a pry-off cap of a bottle. It is preferred that the bottle opener base 151 is attached to the second vertical support rod 122 such that the pivot point 153 is positioned upwards and closer to the first vertical support rod 121. When positioned in the preferred orientation, the leverage cap hook 152 is faced downward, thereby allowing the user 190 to position the bottle upright as the user 190 removes the cap or top off the bottle. When not in use, the leverage cap hook 152 may be positioned in a closed position by pushing the leverage cap hook 152 in a downward motion towards the bottle opener base 151.

FIG. 2B illustrates a perspective view of one potential embodiment of the various beverage holders 130 of the consumer product holding device 100 of the present invention in accordance with the disclosed architecture. The holders 130 are useful for supporting a cup, mug, can, bottle, or any other beverage container, food item, set of keys, phones, or other like item within convenient reach of the user 190. Although the preferred use of the beverage or product holder 130 is for containers intended for human consumption, it is not so limiting, and may be used for any other purpose that may satisfy the needs and/or preferences of the user 190.

The beverage holder 130 is preferably generally cylindrical in shape, and has a sidewall 131 that extends from a base 133 to a rim 137, a top opening 135 therein that is sized and configured for the receipt of a beverage container or other product 180, and a bottom opening 132. The beverage holder 130 may also have a collapsible or flexible material that enables the beverage holder 130 to be stored in a flattened condition when not in use and prior to set up. The beverage holder 130 may also have a foam lining to help keep the beverage cold during hot days (or warm during cold days). In addition, the base 133 of the holder 130 may be provided with an opening 132 to allow condensation from cold beverages or other products to drain out of the holder 130. In one embodiment, the rim 137 may be designed with a curvature, whereby the sides parallel to each other descend from the back portion 139 and ascend towards the front portion 138 of the beverage holder 130, thereby forming a somewhat C-shape on either side. The back portion 139 of the side wall 131, where the elongated key-shaped holes 134 are located, is generally taller in height, while the front portion 138 of the sidewall 131 facing outwardly is generally shorter in height. That is, the back edge of the holder 130 tapers toward the front edge of the holder so that the package or container is easy for the user 190 to remove from the holder 130. The curves along the sides of the sidewall 131 are generally the lowest portion of the sidewall 131. Nonetheless, other shapes and sizes of the beverage holders 130 can also be provided to receive other items, such as sunscreen lotion, sunglasses, a clock, wireless speakers or any other sort of consumer product that the user 190 may desire during his or her outing.

As best shown in FIG. 2B, the base 133 is comprised of a bottom 136 having a continuous opening 132 therein. More specifically, in the preferred embodiment, the bottom opening 132 is a circular shape but may be of any shape or size suitable for holding objects and preventing those objects from falling out of or protruding from the bottom opening 132. The bottom 136 may be integrally formed with the sidewall 131, or attached to the sidewall 131 through any suitable connection or fastening mechanism, such as adhesive, tape, glue, hook and loop fasteners or the like.

The holders 130 are generally removable from the vertical support 120. In a preferred embodiment, elongated key-shaped holes 134 are located along the back portion 139 of the sidewall 131, wherein the two elongated key-shaped holes 134 are positioned on top of each other and situated at a distance equal to the distance of the brackets 125. The beverage or consumer product holders 130 may then be attached to the vertical support 120 by placing the elongated key-shaped holes 134 over the brackets 125. Once the brackets 125 fully extend through the elongated key-shaped holes 134, the beverage holder 130 is pushed in a downward motion (i.e., in the direction of the base 140), thereby removably locking the beverage holder 130 and securing it in place. Alternatively, the beverage holders 130 may be permanently affixed to the vertical structural support 120 via one or more fasteners (not shown) to meet the needs of the user 190.

An insulated insert 170 is removable from the beverage holder 130. The insulated insert 170 is comprised of an insulated insert body 171 that may be the same size and shape of the beverage holder 130, an upper open end 172 and a lower open end 173, as best shown in FIG. 2A. The insulated insert 170 fits snugly to the interior of the sidewall 131 of the beverage holder 130, and is further comprised of an insulating material to keep the beverage container 180 stored therein in a heated or cooled state.

FIG. 2C illustrates a perspective view of one potential embodiment of the consumer product holding device 100 of the present invention in accordance with the disclosed architecture, wherein the device 100 is unassembled. As illustrated in FIG. 2C, the stand 140 is comprised of an inner base 141, a plurality of legs 144 and a stake 146. In a preferred embodiment, the inner base 141 is generally square in shape, and comprised of four flat side walls 147 of equal length. The inner base 141 is further comprised of a flat surface on the top and bottom with an inner base connection hole 143 located approximately in the middle of the inner base 141.

A stake 146 is inserted into the inner base connection hole 143. In a preferred embodiment, the stake 146 is made of the same materials and has the same shape as the first vertical support rod 121 and second vertical support rod 122, but may be any shape and size to meet the needs of the user 190 while allowing for the connection to the second vertical support rod 122. Approximately half of the length of the ground stake 146 may be extended below the inner base 141 and be pushed into the ground thereby providing support for the event convenience device 100 on an uneven surface, such as sand, grass, or the like. When not in use, the ground stake 146 may be positioned such that the bottom of the ground stake 146 is flush with the inner base bottom 142 of the inner base 141. The ground stake 146 may be fastened through any suitable connecting or fastening mechanism including, without limitation, fasteners, clips, bands or clamps.

Each of the four legs 144 are generally rectangular in shape and taper generally towards the outer distal end 148. In one embodiment, a peg 145 is located on the inner side 149 of each leg 144 closest to the inner base 141. The leg 144 is attached to the inner base 141 by inserting the peg 145 into the inner base connection hole 143 in such a fashion that the leg 144 is securely affixed to the inner base 141. Alternatively, the leg 144 may be affixed to the inner base 141 by any other suitable fastening means that allows for the legs 144 to attach to the inner base 141 and prevent the device 100 from wobbling, falling or tilting. The bottom of each leg 144 may further contain a mechanism to prevent the device 100 from sliding on a smooth surface, such as a non-slip material, rubber, etc.

As best shown in FIG. 2C, the bag holder 160 is comprised of a horizontal cross member 161, two side bars 163, and a fastening mechanism 165. More specifically, the side bars 163 are positioned in a generally parallel, spaced apart relationship to one another, and roughly perpendicular to cross member 161 and may be formed as one single elongated member that has two 90-degree angles for side bars 163. Alternatively, the side bars 163 may be attached to the horizontal cross member 161 using any suitable connecting or fastening mechanism including, without limitation, fasteners, adhesives, friction or interference fits, etc.

The horizontal cross member 161 further comprises a fastening mechanism 165, which in this instance is a generally c-shaped clip that is positioned at a midpoint along the member 161 between the side bars 163 and extends outwardly in the same direction as the side bars 163. The fastening mechanism 165 allows the bag holder 160 to be secured at any point along the vertical support 120 to suit the needs and/or preferences of the user 190. In a preferred embodiment, the fastening mechanism 165 would be affixed to the second vertical support rod 122 below the last bracket 125 to ensure balance and stability, and to avoid spilling the contents of the bag 164. Also, the fastening mechanism 165 should have sufficient strength to support contents of different weights, and may be manufactured from any suitable material such as, but not limited to, aluminum, alloy, plastic, wood or the like, provided that the same is relatively anti-corrosive, lightweight, strong, and durable.

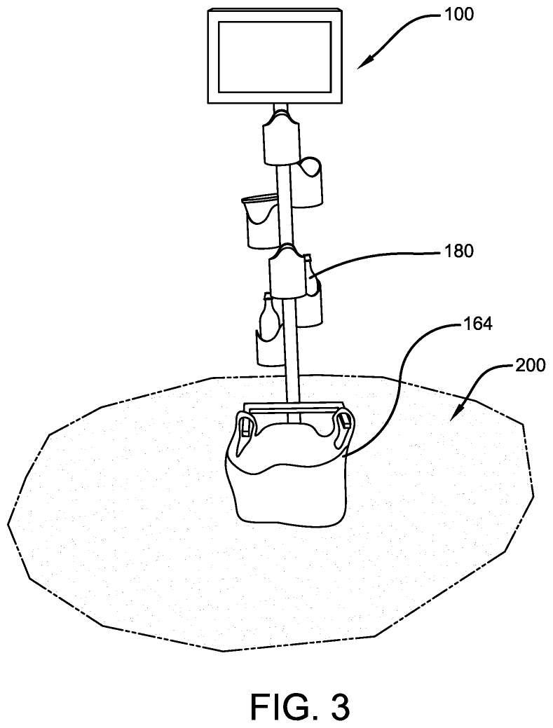

FIG. 3 illustrates a perspective view of one potential embodiment of the consumer product holding device 100 of the present invention in accordance with the disclosed architecture, wherein the device 100 is fully deployed and supporting a trash bag 164. In this particular embodiment, the device 100 is placed on a grassy surface and the ground stake 146 is extended into the ground to provide greater stability for the device 100. In addition to providing the user 190 with a means to hold beverages or other consumer product containers 180 in close proximity to the user 190, the device 100 also provides a way for the user 190 to collect trash for disposal at a later time. Nonetheless, the bag holder 160 may also be used to hold other items, such as pens, pencils, sporting equipment or other necessary items.

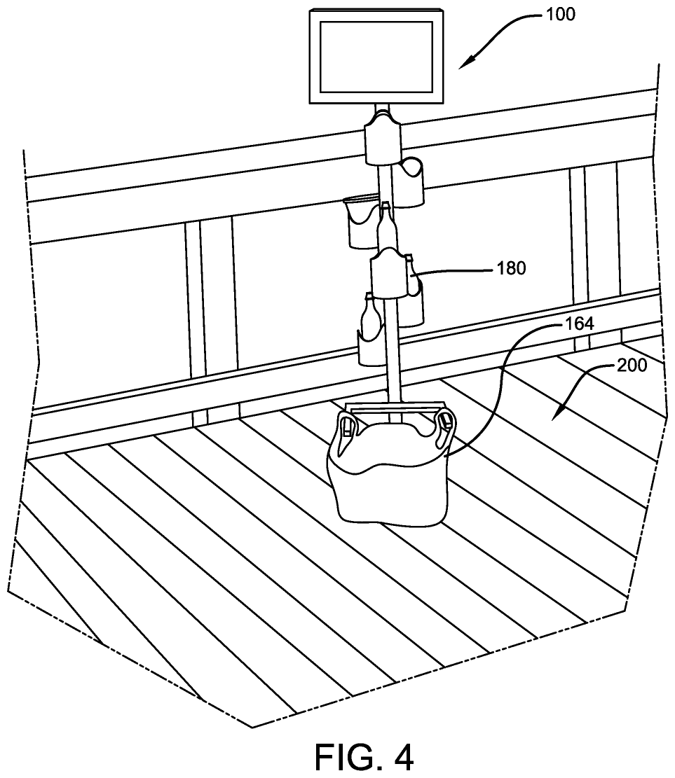

FIG. 4 illustrates a perspective view of one potential embodiment of the consumer product holding device 100 of the present invention in accordance with the disclosed architecture, wherein the device 100 is fully deployed and supporting a plurality of different beverage containers 130. In this particular embodiment, the device 100 is placed on a solid surface where the ground stake 146 would be in an elevated position attached to the inner base 141 in such a way as to prevent the ground stake 146 from being depressed in the surface. FIG. 4 also illustrates the ability of the bag holder 160 to support a bag 164, and provide a secure and stable place to collect trash for later disposal. Further, in this particular embodiment, the device 100 is absent the accessory 110, but is still capable of supporting different sizes and shapes of beverage or consumer product containers 180.

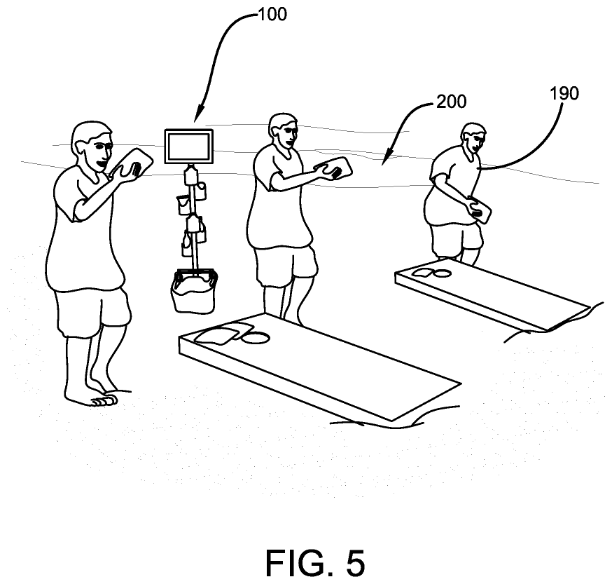

FIG. 5 illustrates a perspective view of one potential embodiment of the consumer product holding device 100 of the present invention in accordance with the disclosed architecture, wherein the device 100 is fully deployed on a beach in close proximity to a plurality of users 190 enjoying a game of cornhole on a beach. In this particular embodiment, the ground stake 146 would be extended into the sand to provide a greater stability for the device 100. Each user 190 has a different colored beverage holder 130 in which to place his/her beverage container 180. In this manner, the device 100 provides a way to keep the beverage containers 180 from spilling onto the sand or becoming contaminated with dirt, sand, bugs, etc. Further, the accessory 110 allows the users 190 to write the scores of each game along with the users' names.

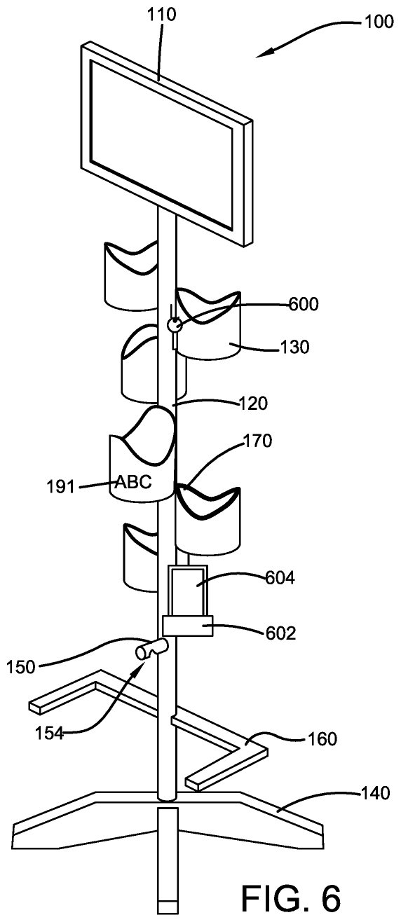

FIG. 6 illustrates a perspective view of one potential embodiment of the consumer product holding device 100 of the present invention in accordance with the disclosed architecture, wherein the device 100 is fully deployed and supporting additional holders or accessory keepers such as a hook for keys 600 and a support 602 for a smartphone or speaker 604. In addition, FIG. 6 shows indicia 191 disposed on the beverage or consumer product holders 130. The indicia 191 for each holder 130 may be personalized with a name, different team logos, events, places or the like.

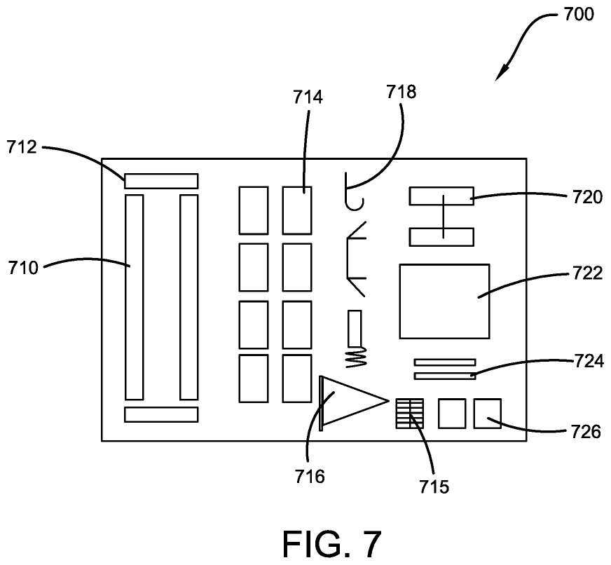

FIG. 7 illustrates a perspective view of one potential embodiment of the consumer product holding device kit of the present invention in accordance with the disclosed architecture. The kit includes a package 700 suitable for retail sales or for delivery if ordered online, and comprises support poles 710, one of more of which may be of the same or equal size, and additional extension poles 712 which may be added to increase the overall height of the main support pole. The extension poles 712 may be of the same size as the main support poles 710, or may be of different sizes. The kit is shown with a number of holders 714, and a sheet of labels 715 may also be provided to personalize the holders 714 if they are not purchased with some existing personalization or other indicia to distinguish one holder 714 from another. The kit may also include a flag 716 which can be inserted in an opening in the top of the support pole 710 to help event participants find their location. A number of accessory hangers 718 may also be included for hanging or supporting different types of accessories from the support pole 710. The kit further includes a bag support 720, a base 722 for supporting the main support pole 710, one or more spikes 724 to help secure the base 720 to a surface on which it is placed, and weights 726 to help secure the base 720 on the surface on windy days.

Notwithstanding the forgoing, the consumer product holder device 100 of the present invention and its various components can be of any suitable size and configuration as is known in the art without affecting the overall concept of the invention, provided that they accomplish the above stated objectives. One of ordinary skill in the art will appreciate that the size, configuration, and material of the consumer product holder device 100 and its various components as shown in the FIGS. are for illustrative purposes only, and that other configurations of the consumer product holder device 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A consumer product holder device comprising:
a central support comprised of first end, a second end and a length, wherein a number of slots are disposed along the length of the central support;
a base, wherein the central support is removably attached to the base at the first end;
a plurality of holders, wherein each of the plurality of holders is sized and configured to receive a consumer product; and
at least one accessory.

2. The consumer product holder device as recited in claim 1, wherein the base further comprises a repositionable stake that is at least partially inserted into an opening in the central support.

3. The consumer product holder device as recited in claim 1, wherein at least some of the plurality of holders comprise a foam insert.

4. The consumer product holder device as recited in claim 1, wherein at least some of the plurality of holders taper from a back edge to a front edge.

5. The consumer product holder device as recited in claim 4, wherein at least some of the plurality of holders comprise a drain hole.

6. The consumer product holder device as recited in claim 1, wherein the at least one accessory is removably attached to the second end of the central support.

7. The consumer product holder device as recited in claim 1 further comprising at least two of the following accessories: (a) a dry-erase board; (b) a sign; (c) an umbrella; (d) a bottle opener; (e) a key holder; (f) a flag; (g) a speaker; (h) an eye hook; and (i) a light.

8. The consumer product holder device as recited in claim 1 further comprising a central support extension.

9. The consumer product holder device as recited in claim 1 further comprises a bag holder.

10. The consumer product holder device as recited in claim 9, wherein the bag holder further comprises a cross member and a pair of arms, and further wherein each of the pair of arms extend outwardly from, and is perpendicular to, the cross member.

11. The consumer product holder device as recited in claim 1, wherein the central support is comprised of a first portion and a second portion that is removably attached to the first portion.

12. The consumer product holder device as recited in claim 1, wherein each of the plurality of holders is provided with an indicia to distinguish it from each of the other plurality of holders.

13. A consumer product holder device kit comprising:
a package sized and configured to hold a number of components to assemble a consumer product holder device;
a first support pole;
a second support pole;
at least one extension pole;
a base; and
a plurality of holders.

14. The consumer product holder device kit as recited in claim 13 further comprising a flag, a stake, a spike and a weight.

15. The consumer product holder device kit as recited in claim 14 further comprising a plurality of labels for personalizing each of the plurality of holders.

16. The consumer product holder device kit as recited in claim 15 further comprising at least two accessory holders.

17. The consumer product holder device kit as recited in claim 16 further comprising a bag support comprised of a cross member and a pair of arms extending outwardly therefrom.

18. A consumer product holder device comprising:
a plurality of product holders each sized and configured to receive one of a beverage, a snack package or a consumer item;
a pole having a first section, a second section, a first end and a second end, wherein each of the first and second sections are comprised of at least one opening for holding at least one of the plurality of product holders;
a base for receiving the first end of the pole;
a bag support disposed near the first end of the pole and above the base; and
an accessory disposed at the second end of the pole.

19. The consumer product holder device as recited in claim 18, wherein the accessory is selected from a group including a dry-erase board, a sign, an umbrella, a key holder, a flag, a smartphone holder, a speaker, a light, an eye hook or a combination thereof.

20. The consumer product holder device as recited in claim 19, wherein each of the plurality of holders is personalized with an indicia.
